(19) United States
(12) Patent Application Publication
(10) Pub. No.: US 2015/0089203 A1
(43) Pub. Date: Mar. 26, 2015

(54) LATENCY REDUCTION IN DISTRIBUTED COMPUTING ENVIRONMENTS

(71) Applicants: Mitch Kline, Dallas, TX (US); Joel Simon, Cleveland, OH (US)

(72) Inventors: Mitch Kline, Dallas, TX (US); Joel Simon, Cleveland, OH (US)

(21) Appl. No.: 14/034,393

(22) Filed: Sep. 23, 2013

(51) Int. Cl. G06F 9/30

(52) U.S. Cl. CPC G06F 9/30145
USPC 712/220

(57) ABSTRACT

Systems and methods that facilitate anticipatory execution and provision of possible instructions receivable by a computing environment are described herein. A state management component identifies the possible instructions, and defines a prediction space. A predictor component selects one or more possible instructions to be executed by a processor module. In one embodiment, a portion of a computing environment is hosted at a data center, and a user interacts with the computing environment via a terminal computing device. A possible instruction receivable by the terminal is identified and executed before such instruction is issued, and resulting information is preemptively delivered to the terminal computing device, which accesses the information when such instruction is issued.

### BACKGROUND

Factors such as economies of scale and convenience, as well as an emerging pay-as-you-go framework for moving storage and computing into the cloud have led businesses, as well as individuals, to increasingly outsource their computing infrastructure needs. Maintaining infrastructure necessary to support peak usage or demand can be inefficient—such hardware is infrequently utilized to its full potential, while normal usage may only require a fraction of the available computing power. Thus, companies, such as Amazon, have begun offering services whereby they effectively rent out portions of their data center to host material on the web, or perform computationally intensive tasks. Customers who employ such services may no longer have to maintain as much expensive hardware; their infrastructure becomes elastic, in the sense that only resources needed for a task at hand are operating on their behalf. Customers pay for only the resource they use, when they use them.

Several technical hurdles impede the progress and adoption of cloud computing, including speed and cost of hardware, bandwidth, and latency. Not only can latency refer to physical limitations on transmitting data (time needed for a message to navigate through a network, e.g., a ping), but also can refer to time needed to execute cloud-based tasks such as data management and processing.

It is notable that resources in a computing system are not utilized to their full potential all of the time. These resources include, for example, those that allow for information to be accessed, those that allow information to be processed, and those that allow information to be transported. Inevitably, there are periods of time during the operation of a computing system in which processors are idle, memory is not being accessed, and/or bandwidth is under-utilized. These periods of “dead-weight time” have, thus far, not been exploited to increase the productivity of a computing system. Indeed, traditional computing systems have not necessitated the utilization of dead-weight time. In fact, other concerns, such as power consumption, render the exploitation of dead-weight time in traditional computing systems an unattractive strategy.

Caching is a strategy used to mitigate the latency associated with accessing data located at a distance. Caching is commonly utilized by processors to speed up access to frequently used data in RAM. More recently, caching has been implemented in the context of the internet. Content distribution networks (“CDNs”) utilize caching to store information, such as a website, closer to end users, so that it can be accessed more quickly. Traditionally, cache has been used to duplicate and store already existing information so that it is located where it is more conveniently read and manipulated.

However, caching, is not suitable for all types of information, and thus has a limited utility on its own. Thus, there is a need for a technology that can compensate for latency that is incurred when data is transmitted over distances to be processed. Even small delays can negatively impact a user's experience when operating a computing device, as it is generally desired that interactions with a computing device be fluid and seamless.

### SUMMARY

The following is a brief summary of subject matter that is described in greater detail herein. This summary is not intended to be limiting as to the scope of the claims.

The present invention provides a solution to, inter alia, the problem of latency in a computing environment, by performing computations and/or causing results of such computations to be available in anticipation of a user's instruction to do so. In one embodiment, the computing environment is hosted remotely in, for example, a data center. A virtual machine may be constructed from computing elements located in the data center and/or geographically distributed computing elements to host the computing environment. The state of the computing environment is transmitted to a user terminal, from which the user may interact with the computing environment.

Once a computing environment has been instantiated, it will begin in a first state, which a user may alter by issuing an instruction (usually in the form of an input from, e.g., a mouse or keyboard). In order to transition to a subsequent state, the computing elements may access and process data (i.e., perform computations). The data retrieved/accessed and the computations performed vary depending on the particular instruction from the user. If the virtual machine needs to wait to receive a user's instruction, the user must endure the delay associated with transmitting the executed instruction back to the user terminal.

Instead, in an embodiment, a computing environment according to the present invention predicts at least one possible future instruction, based on the current state of the computing environment. The computing elements are then used to execute one or more of the possible future instructions, and return the states of the computing environment associated with each of the possible future instructions. The computing elements may, alternatively, compute selected information relevant to a respective state. These possible future states, or portions thereof, are transmitted to the user terminal, where they are stored, pending the user issuing an instruction.

When the user actually issues an instruction, the user terminal simply accesses the state associated with that instruction from its memory, and discards of the possible states that are no longer useful. The user terminal also transmits the instruction to the computing elements, so that the computing environment can update its state, and perform another set of predictions and computations based on the predictions. This process repeats itself as the user interacts with the user terminal, and reduces latency due to transmission and computing time.

In another embodiment of the present invention, the user terminal may include computing capacity beyond that which is necessary to perform basic functions. For example, a user terminal may include a graphics processor and may include an application processor. This feature of the present invention allows the terminal and the remote computing elements to share the responsibility of advancing the computing environment, and performing calculations. In an embodiment, the terminal executes all instructions that require less than a threshold amount of computation. Instructions that are more computationally intense are executed remotely, the result of which is transmitted to the terminal. Such a system may also utilize a prediction framework, as described in further detail below. The computing environment may predict potential instructions and determine where such instructions will be executed.

Hardware hosting the computing environment may be distributed such that a portion of the storage and/or processing resources are located proximate to the terminal. The computing environment may strategically execute potential instructions, and store all or a portion of the executed instructions on these proximately located computing resources. Such resources, if available, can be incorporated into the present invention to operate the computing system more efficiently, increase the probability of relevant information being readily available to a terminal, and/or decrease the storage and processing demands on the terminals.

A computing environment may also, for example, predict a number of potential future instructions. A first tier of predicted instructions, determined to be most likely, may be executed and transmitted to the terminal for storage; a second tier of predicted instructions, determined to be less likely, may be executed and transmitted to an edge server for storage. Should one of the tier two instructions be issued to the computing environment, the executed instruction can be transmitted to the terminal from server resource with lower latency than if it had been transmitted from more distant resources. Server resources may also be used to execute all or a portion of the predicted instructions.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary embodiment of a computing environment which facilitates reducing latency.

FIG. 2 is an exemplary illustration of a tree-map of a prediction space.

FIG. 3 is a functional block diagram of an exemplary computing system configured to host a computing environment.

FIG. 4 is a flow diagram illustrating an exemplary methodology that facilitates reducing latency in a computing environment.

FIG. 5 is a high-level functional block diagram of an exemplary computing device.

### DETAILED DESCRIPTION

Various technologies pertaining to anticipatory execution and provision of possible instructions receivable by a computing environment are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. The articles “a,” “an,” and “the” should be interpreted to mean “one or more” unless the context clearly indicates the contrary. The term “includes” is used interchangeably with the term “comprising.” Additionally, as used herein, the term “exemplary” is intended to mean serving as an illustration or example of something, and is not intended to indicate a preference.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

The present disclosure describes techniques of reducing latency in a computing environment. Such techniques include performing computations or executing instructions and/or providing results of such computations or execution to the computing environment prior to receiving instructions to do so.

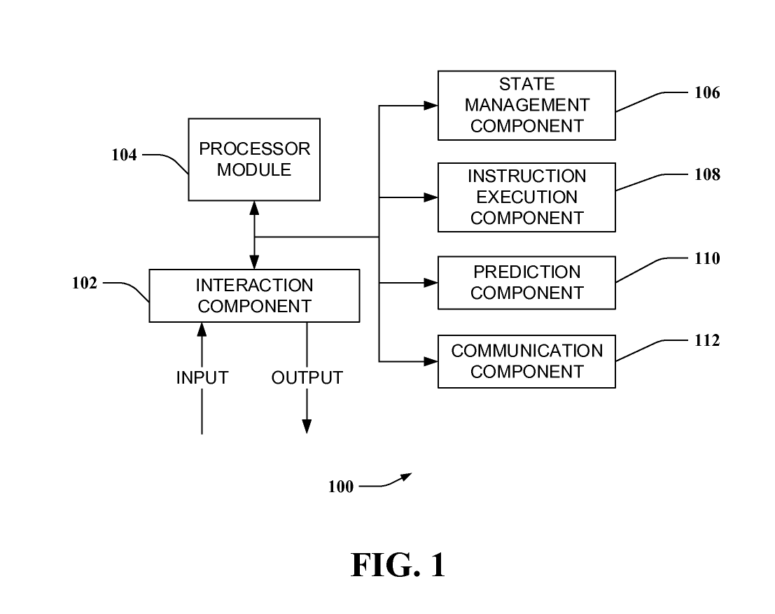

Referring now to FIG. 1, an exemplary computing system 100 that hosts a computing environment that facilitates reducing latency is illustrated. As used herein, “computing environment” refers to a distribution of hardware and software that form a logical unit. The computing environment comprises an interaction component 102. The interaction component 102 receives input information such as, for example, input from a user or an electronic signal such as from a sensor, another computing device, or an input device such as a mouse, keyboard, touch sensitive display, etc. The interaction component 102 is in communication with a processor module 104, and is also configured to cause information to be output from the computing environment.

The processor module 104 comprises at least one processor core that executes instructions stored in computer readable media comprised by the computing environment. In an embodiment, the processor module 104 is distributed amongst a plurality of devices in the computing environment. The processor module 104, based at least in part upon information received from the interaction component 102, executes instructions in order to transition the computing environment from one state to another.

As referred to herein, “state” refers to information that represents a discrete condition of the hardware and software comprised by the computing environment. In an example, the computing environment is in a first state. The interaction component 102 receives information, such as a user instruction. The information is transmitted to the processor module 104, which executes instruction(s) based at least in part upon the information. As a result of executing the instruction(s), at least a portion of the first state is manipulated, thus transitioning the computing environment into a second state, i.e., a state responsive to the information received by the interaction component 102. Information representing at least a portion of the second state can be transmitted to the interaction component 102, which can cause information to be outputted from the computing environment that is representative of the second state.

In another example, while in a first state, the interaction component 102 causes a display of a device to display information representative of one or more instructions that may be issued by a user. The user selects an instruction from amongst the one or more instructions. The interaction component 102 receives the selection, and transmits such selection to the processor module 104. The processor module executes the instruction responsive to receiving the selection, manipulating the first state into a second state. This second state is that which results from the user having issued the instruction. Information representing such manipulation is transmitted to the interaction component 102, which causes the display to display, for example, the result of the executed instruction and/or other information pertaining to the second state. Thus, each time the processor module 104 executes instruction(s), the computing environment transitions to a respective state.

Such state transitions are generally characterized by an amount of latency, or a delay between the time when information is received by the interaction component 102 while the computing environment is in a first state, and the time when information representative of a second state is output by the interaction component 102. Latency can negatively impact a user's experience when interacting with the computing environment. For instance, in the example above, delay between when an entity is selected by a user and when a responsive action is displayed on the display of the device may induce the user to believe the computing environment is malfunctioning, slow, non-responsive, of low quality, etc. Latency can arise due to various factors that include, but are not limited to travel latency, bandwidth latency, and execution latency.

Travel latency refers to time needed for information to travel from one physical point to another. For example, an interaction component 102 may be comprised by a first computing device, and a processor module 104 may be comprised by a second computing device. Relaying the information from the interaction component 102 to the processor module 104 may comprise travelling via a network, such as the internet. Similarly, there is a time needed for information generated by the processor module 104 to be relayed to the interaction component 102. Generally, such time periods are precipitated by a rate at which information can travel (i.e., through wires or via radios, as well as through routers, switches, etc. present in the network).

Bandwidth latency refers to time needed in order to relay information given a finite signal capacity. For example a network provides a bandwidth of 10 MB/sec, while information to be relayed is 100 MB. Regardless of how far the information needs to travel, the bandwidth of the network limits how quickly it can be transmitted, i.e., 10 MB/sec over 10 seconds for 100 MB.

At least a portion time during use, a processor module 104 may be accumulating dead-weight time, or time in which the processor module 104 is executing instruction(s) at a rate below an operating capacity. For example, a processor module 104 may be idle while information is being transmitted to or from the interaction component 102, the processor module may comprise more operating capacity than is necessary to execute instruction(s) to transition from a first to a second state, or the processing module 104 may be idle while the interaction component 102 is waiting to receive further information, etc. Additionally, dead-weight time may accumulate when a computing environment is waiting for an instruction to be received. For example, while a computing environment is waiting to receive an instruction from another computing device, the processor module 104 may not be exercising its full operating capacity.

As described below, latency can be reduced and dead-weight time can be exploited by executing instruction(s) during dead-weight time for states to which the computing environment may or may not transition. Information may also be transmitted that is representative of such states prior to receiving information that would cause a state transition. Generally, it is not necessary to execute instruction(s) for all states, as a finite number of states can be transitioned to from any particular state, and thus represent a set of possible states to which the computing environment could transition responsive to receiving respective input information. In other words, for any particular state, there are a finite number of possible instructions that can cause the computing environment to transition into a finite number of possible states. Possible instructions can comprise, for example, at least one of machine code, executable computer code, a GUI interaction, a user interaction, a received signal, or a combination thereof that is receivable by the computing environment in a current state.

The computing environment further comprises a state management component 106. Based at least in part upon an examination of a current condition of hardware and software comprised by the computing environment, the state management component 106 identifies information indicative of at least a portion of a current state of the computing environment.

The information indicative of at least the portion of the current state of the computing environment can comprise at least a portion of, for example, information received by the processor module 104 from the interaction component 102, information stored in a computer readable media comprised by the computing environment, a virtual machine executing within the computing environment, etc., or a combination thereof. Such information may include various types of input receivable by the computing environment, and may include, for example, information about user instructions, sensor readings, transmissions from other devices or computing environments, location information such as location of a device, user, etc., time information such as current time, travel time, times of events, etc., current conditions of the computing environment such as operating capacity available, memory available, devices comprised by the computing environment, users in communication with the computing environment, etc., or a combination thereof.

Based at least in part upon the information indicative of at least a portion of the current state, the state management component 106 identifies at least one possible instruction receivable by the computing environment. As described above, for any particular state, there are a finite number of possible instructions that can cause the computing environment to transition into a finite number of possible states. Thus, in an example, the state management component 106, using the information indicative of at least a portion of the current state, can identify at least one possible instruction receivable by the computing environment in the current state that would cause the computing environment to transition to a corresponding possible state. In an example, information indicative of at least a portion of a current state includes data with respect to a user interface (UI) configured to receive a user action. The user action thus represents an instruction that is receivable by the computing environment, but has yet to be issued by the user or received by the computing environment.

As referred to herein, a possible instruction is an instruction that is receivable by the computing environment, but has yet to be received. Accordingly, a possible state refers to a state, to which the computing environment would transition were it to receive the possible instruction.

The computing environment further comprises an instruction execution component 108 configured to cause the processor module 104 to execute one or more of the at least one possible instructions. In some embodiments, the execution component is integrated into the processor module. In some embodiments, the instruction execution component 108 is comprised by a system memory available to the processor component 104, such as a distributed memory, local RAM, etc. As referred to herein, instructions or commands transmitted to the instruction execution component 108 can also be referred to as transmitted to the processor module.

In an example, the computing environment is in a first state, wherein a first instruction is receivable by the computing environment in the first state. As the first instruction has yet to be received, the first instruction is a possible instruction. The processor module 104 would generally be idle, and thus would be accumulating dead-weight time. By having the instruction execution component 108 cause the processor module to execute the first instruction as a possible instruction, i.e., before it is received by the computing environment, such dead-weight time can be exploited to reduce latency. For instance, executing the first instruction may comprise a processing latency, etc. By beginning execution of the possible instruction prior to the first instruction being received by the computing environment, such execution will already be in progress or may even be complete when the first instruction is actually received. In other words, a time delay resulting from processing latency, etc., is reduced due to an amount of time and/or processing power which the processor module 104 spends executing the possible instruction before it is received.

In some embodiments, the state management component 106 can identify at least one possible instruction receivable by the computing environment in a possible state, corresponding to an identified possible instruction. In an example, a computing environment in a first state is configured to transition into a second state responsive to receiving a first possible instruction. The computing environment has knowledge, such as via a computer readable memory available to the computing environment, that a second possible instruction is receivable to the computing environment in the second state, wherein receiving the second possible instruction would cause the computing environment to transition from the second state to a third state. Thus, even though the computing environment is in the first state, when the computing environment has knowledge of possible states such as the second state, information about further possible states stemming from other possible states can be identified.

As referred to herein, “verticality” or “vertical states” refer a quantity of instructions and corresponding intermediary states that separate two different states. In an example, a first or current state branches into a second state, which in turn branches into a third state. The second state has one level of verticality relative to the current state, while the third state has two levels of verticality—as two instructions, one to transition from the first state to the second, and one to transition from the second to the third—separate the third state from the first. The state management component 106 can be configured to identify possible instructions with varying degrees of verticality. By identifying possible instructions corresponding to additional vertical states, the state management component can further leverage dead-weight time of the processor module 104.

In some embodiments, the state management component 106 can identify a plurality of possible instructions receivable by the computing environment in a particular state. In an example, N possible instructions respectively comprise instructions to access one of N files stored in computer readable memory available to the computing environment in the particular state. As referred to herein, “horizontality” or “horizontal states” refer to states that share a common degree of verticality relative to a particular state. By identifying a plurality of possible instructions corresponding to a plurality of horizontal states, the state management component 106 can account for a broader range of possible interactions, and thus increase a probability of latency being reduced.

The horizontal and/or vertical states identified by the state management component 106 thus incorporate the identified possible instructions and define a prediction space that comprises information describing relationships between possible instructions, and may also comprise other predictive data, described below. In an example, a prediction space for a computing environment is predetermined. Such a predetermined “map,” for example, can describe an entirety of possible states for the computing environment. In another example, the state management component identifies at least a portion of an entirety of all possible states of the computing environment. For instance, the state management component 106 can be configured to create a prediction space that accounts for n levels of verticality relative to a current state, and can further be configured to update such prediction space as the computing environment transitions from state to state.

The computing environment further comprises a prediction component 110 that selects possible instructions to be executed by the processor module 104, thus defining a prediction selection or selection space. As described above, the state management component 106 can identify a plurality of possible instructions corresponding to one or more vertical and or horizontal states. In an example, the predictor component 110 selects less than the entirety of the plurality of possible instructions receivable by the computing environment for execution by the processor module and/or selects a priority of execution for the possible instructions to be executed. Instructions may be prioritized and queued accordingly by the processor module 104.

Such selections of priority and/or how many possible instructions are to be executed can be performed using, for example, an algorithm, selection metric, or the like that is configured to optimize a probability that latency is reduced. Further, such selection can be based on a plurality of factors relating to, for example, parameters and characteristics of the computing environment, factors indicative of likelihoods of receiving possible instructions, processing or communication costs, branching costs, or other factors.

Parameters and characteristics of the computing environment include, without limitation, what devices are powered and/or active in the computing environment, distance between different hardware devices comprised by the computing environment, bandwidth and/or travel time between the different hardware devices, processing and/or storage capacities of the hardware devices, whether other devices, environments, networks, etc., are in communication with the computing environment, available input and/or output devices, and network traffic and/or quality conditions.

Factors indicative of likelihoods or receiving possible instructions include, without limitation, usage statistics, such as history of a user or users, interactions with other devices, computing environments, etc., a number of circumstances in which a particular possible instruction is receivable, and whether and how a particular possible instruction affects further vertical states.

Factors indicative of processing costs include, for example, time needed to execute a particular possible instruction, time needed to access computer readable memory for executing the particular possible instruction, and an amount of computer readable memory used to execute the particular possible instruction. Factors indicative of communications costs include, for example, network conditions, communications used to execute the particular possible instruction, data read/write times, Factors indicative of branching costs include how many vertical and/or horizontal states stem from a particular state, and whether resources are shared by vertical and/or horizontal states.

The following examples of selections by the predictor component 110 are included for the purposes of illustration only, and are not intended to be viewed as limitations.

In an example, a computing environment in a first state is configured to receive a first possible instruction and a second possible instruction. Past users behavior metrics indicate that there is a 60% chance of the first possible instruction being received and a 40% chance of the second possible instruction being received. Data on processing costs indicates that executing the first possible instruction will take one third of the time needed to execute the second possible instruction. Using a prediction algorithm, the prediction component determines that latency resulting from executing the second possible instruction has a higher chance of interfering with operation of the computing environment due to the longer execution time, and selects the second possible instruction as a top priority for execution.

In an example, a computing environment in a first state is configured to receive a first possible instruction and a second possible instruction. Past users behavior metrics indicate that there is a 60% chance of the first possible instruction being received and a 40% chance of the second possible instruction being received. Data on processing costs indicates that executing the first possible instruction will take one twentieth of the time needed to execute the second possible instruction. Using a prediction algorithm, the prediction component determines that the executing the first possible instruction before the second possible instruction would incur a negligible increase in latency for executing the second possible instruction, as the second possible instruction already has a significant execution time, and selects the first possible instruction as top priority for execution.

In an example, a computing environment in a first state is configured to receive a first possible instruction and a second possible instruction. Past users behavior metrics indicate that there is a 60% chance of the first possible instruction being received and a 40% chance of the second possible instruction being received. Verticality and/or horizontality information indicates that the first possible instruction would cause the computing environment to transition to a second state configured to receive a third possible instruction (100% chance), and that the second possible instruction would cause the computing environment to transition to a third state configured to receive a fourth possible instruction (80% chance) and a fifth possible instruction (20% chance). Using a prediction algorithm, the prediction component determines that there is a reasonable chance that the first possible instruction will be received over the second possible instruction, and thus that there is a high probability of receiving the third possible instruction. The prediction component also determines, however, that if the second possible instruction is received, there is a high probability of further receiving the fourth possible instruction. Thus, the prediction component can assign a top priority to the first possible instruction, a secondary priority to the second and third possible instructions, a tertiary priority to the fourth possible instruction, and a quaternary priority to the fifth possible instruction.

In an example, a computing environment in a first state is configured to receive a first possible instruction, a second possible instruction, and a third possible instruction. Past users behavior metrics indicate that there is a 20% chance of the first possible instruction being received, a 35% chance of the second possible instruction being received, and a 45% chance of the third possible instruction being received. Information on memory used to execute possible instructions indicates that 50% of available memory is needed to execute the first possible instruction, 20% of available memory is needed to execute the second possible instruction, and 100% of available memory is needed to execute the third possible instruction. Using a prediction algorithm, the prediction component determines that executing the first and second possible instructions would use 70% of available memory and would account for a cumulative 55% chance of one of such instructions being received, while the third possible instruction would use 100% of available memory and only account for a 45% chance. Thus, the predictor component can assign the first and second possible instructions top priority for execution. It should be understood that memory used for execution can refer to system memory, such as RAM, that is used by a processor module during execution, or can refer to other computer readable memory used to store results of such execution or other related data.

In an example, a computing environment in a first state is configured to receive a first possible instruction and a second possible instruction. Information on memory used to execute possible instructions indicates that 5% of available processing power is needed to execute the first possible instruction, and 10% of available processing power is needed to execute the second possible instruction. The prediction component can determine that approximately 85% of the available processing power would remain unoccupied when executing the first and second possible instructions, and can request verticality and horizontality information from a state management component in order to identify further possible instructions to be executed in order to occupy additional available processing power.

It should be understood that the prediction component 110 can be configured to utilize various different algorithms and metrics, such as in the example provided above. In a further example, the predictor component selects an algorithm or metric from amongst a plurality of algorithms and/or metrics for various reasons such as complexity of a particular state, whether operation of the computing environment is time sensitive, etc. In an example, a general algorithm may be used that comprises sub algorithms or metrics that may be selectively utilized.

Thus, the state management component 106 defines a prediction space, i.e., what horizontal and vertical possible states exist for the current state, and the prediction component defines a prediction space and selects which possible instructions, corresponding to such horizontal and vertical states, are to be executed by the processing module 104. Such selection by the prediction component 110 may also include pruning, whereby, for example, the prediction component 110 can create a prediction selection space that comprises less than an entirety of the prediction space.

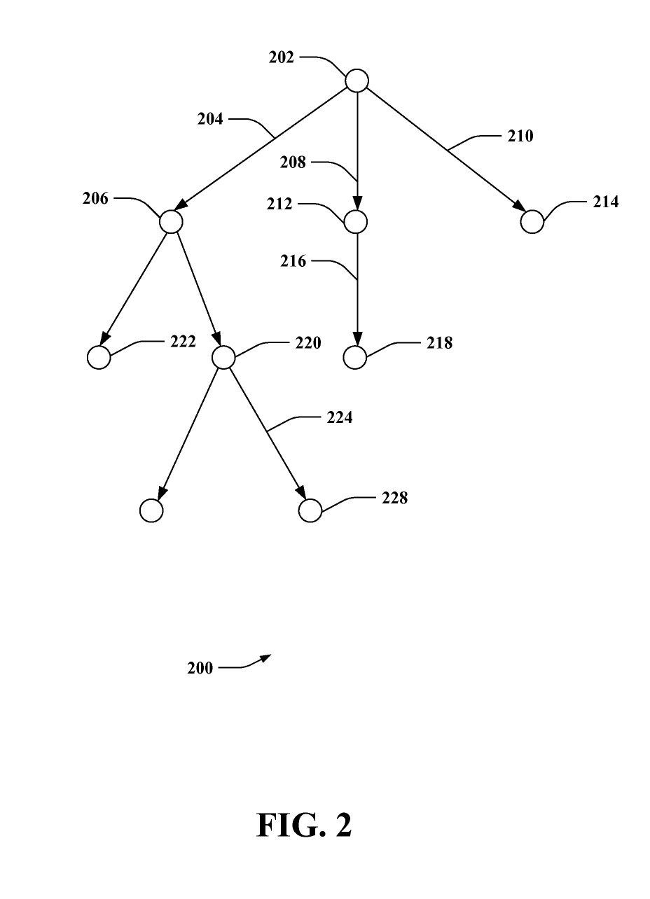

Referring now to FIG. 2, an exemplary tree-map illustration of a prediction space 200 is depicted. While the prediction space 200 is depicted as a tree map, it should be understood that other depictions are also contemplated, such as graphs, directed graphs, linked-lists, charts, tables, etc. As depicted in FIG. 2, states, such as a current state 202 of the computing environment, are points, and possible instructions, such as a first possible instruction 204, are edges connecting a state where the possible instruction is receivable, such as the current state 202, to a state transitioned to by the computing environment responsive to executing the possible instruction, such as a first possible state 206.

As discussed above, one or more instructions are receivable by the computing environment in each state. For example, possible instructions 204, 208, and 210 are receivable by the computing environment in the current state 202, and respectively correlate to possible states 204, 212, and 214. When the computing environment is in some states, such as possible state 212, further possible instructions, such as possible instruction 216, are receivable by the computing environment, and are correlated to further possible states, such as possible state 218.

A plurality of states stemming from a particular state, such as possible states 206, 212, and 214 which stem from the current state 202, are horizontal states, in that they share a common level of verticality, i.e., for each of the possible states 206, 212, and 214, the same number of edges connect a respective possible state to the current state. In another example, the possible state 218 is at the same level of verticality as possible states 220 and 222, as each of such states is connected with the current state 202 by two edges.

Each level of verticality can comprise a respective number of possible states, and thus comprises a respective amount of horizontality. While the prediction space 200 is depicted as having three levels of verticality, it should be understood that prediction spaces identified by the state management component can have varying amounts of levels of verticality.

In some instances, a particular instruction may be receivable by the computing environment at various states, and in some instances execution of this instruction from each of the various states may lead to a common state. For instance, an application may be configured to receive a “quit” command at various states, and thus the possible instructions 210, 216, and 224 can each be a “quit” command receivable by their respective possible states. Additionally, in some instances, at least a portion of information indicative of at least a portion of a first state may overlap with at least a portion of information indicative of at least a portion of a second state. For example, information created responsive to an instruction to display a file may comprise at least a portion of information created responsive to an instruction to display a preview of the file. In such instances, executing instructions or portions of instructions may be redundant.

Thus, referring again to FIG. 1, the state management component 106 can also be further configured to prune the prediction space in such a way that removes redundant possible states and/or instructions, or portions thereof. For example, possible instructions 216 and 224, and/or their respective possible states 220 and 226 can be pruned from the prediction space, and information indicative at least a portion of the possible state 214 resulting from execution of possible instruction 210 can be referenced, or copied, etc. In another example, wherein a portion of possible instruction 208 overlaps with at least a portion of instructions 204 and 224, information resulting from execution of such overlapping portions need only be created once, and can be referenced or copied, etc., for other overlapping possible instructions. Pruning the prediction space as described above can reduce the amount of time needed to execute possible instructions, reduce an amount of possible instructions to be executed, etc. Further, such pruning by the state management component 106, combined with pruning by the prediction component 110, can further reduce the number of instructions, execution time, etc.

As described above, a finite period of time is needed to execute instructions. If an instruction is received that corresponds to a possible instruction not yet executed by the processor module 104, the processor module can be configured to cease executing possible instructions and execute the received instruction. For example, 100 instructions are receivable in a current state. When an instruction from amongst the 100 possible instructions (e.g., a 78th instruction) is received, the processor module has only executed instructions 1-52. Rather than executing instructions 53-77, the processor module 104 ceases executing possible instructions and instead begins executing the 78th instruction. Similarly, it should be understood that if an instruction is received that was not selected for execution by the prediction component 110, the processor module is configured to execute such an instruction responsive to such receipt.

As discussed above, an instruction being executed by the processor module 104 results in information indicative of at least a portion of a state corresponding to the instruction. For example, when the processor module 104 executes a possible instruction, information indicative of at least a portion of a corresponding possible state is created. The processor module 104 is configured to cause such information to be stored in a computer readable memory available to the processor module.

The computing environment further comprises a communication component 112 that provides information indicative of at least a portion of at least one state corresponding to an instruction executed by the processor module 104 to a computer readable memory available to the interaction component 102. When the interaction component 102 receives an instruction corresponding to a possible instruction executed by the processor module 104, the information indicative of a state to which the computing environment is desirably transitioned, e.g., the corresponding possible state, is already on a computer readable memory available to the interaction component 102 and can be immediately accessed. Thus, by being able to immediately access such information, the interaction component 102 can display output that reflects a transition of the computing environment to the desired state immediately, rather than incurring latency delays from communicating with, for example, a server, waiting for an instruction to be executed, etc.

In some embodiments, the communication component 112 provides less than an entirety of information indicative of a plurality of possible states corresponding to a plurality of possible instructions executed by the processor module. For instance, finite capabilities of a device comprising at least a portion of the interaction component 102 may limit how much information can be retained therein. The predictor component 110 can be further configured to use a predictive algorithm or metric similar to those described above to optimize the provision of information indicative of possible states corresponding to a set of the plurality of possible instructions executed by the processor module 104.

For example, the processor module 104 may have executed a first and a second possible instruction, and thus created first and second information indicative of a first and second possible state, respectively. A device comprising the interaction component 102 may only have enough computer readable memory to store one of the first and second information. The prediction component 110 can determine that providing the first information to the computer readable memory on the device optimizes a probability that information corresponding to a received instruction is retained on the device. Based on such determination, the communication component 112 then provides the first information to the computer readable memory on the device.

If an instruction received for which corresponding information is not retained in computer readable memory available to the interaction component 102, the interaction component 102 transmits such instruction to the communication component 112, whereby such information can be transmitted to the interaction component 102, and output to indicate the state transition of the computing environment.

In some instances, rather than transmitting an entirety of information representative of a state, the communication component 112 may instead transmit portions of the information that differ from other information already sent and/or that will be sent. For example, rather than sending information representative of a first and second state, the communication component 112 can transmit information representative of the first state, and portions of information representative of the second state that are not redundant of portions of information representative of the first state. Removing such redundancies can have various beneficial effects, such as reducing a size of transmissions, increasing the amount of states storable by the interaction component 102, or other effects, such as increased security. Redundant or slightly variant information may be susceptible to packet sniffing, interception, or other attacks during transmission. By removing redundant information, such risks can be reduced.

In some embodiments, the interaction component 102 is distributed amongst a plurality of devices. For instance, the computing environment may comprise a plurality of computing devices that communicate via a network, where each device can receive input information and output information indicative of a state of the computing environment. In some instances, multiple devices are configured to display common output information, i.e., a first device displays similar information to a second device, albeit in a different resolution, formatting, etc. In some instances different devices are configured to appear as distinct instances. For example, various devices may be configured to display various portions or aspects of a state of the computing environment.

For example, the computing environment can execute a distributed application such as, for example, a music library application. The interaction component 102 is distributed amongst a first mobile device of a first user and a second mobile device of a second user. Each user desirably accesses a respective personal music library. Thus, the interaction component 102 is configured to output information at the first mobile device which pertains to input received via the first mobile device, and similarly output information at the second mobile device which pertains to input received via the second mobile device. In other words, the computing environment can be configured to maintain separate instances of an application in order provide the appearance of an interaction or experience unique to a user or device.

In an example, a state of the computing environment comprises a plurality of states of a plurality of instances, interactions, experiences, etc. For instance, the computing environment can be configured to maintain one or more instances of an application, wherein each instance is employed by a different user, device, etc. Maintaining such a plurality of states for a plurality of instances of an application can elicit several advantages. Similar to how different states of the computing environment can comprise overlaps, states corresponding to different instances may also comprise overlaps.

In other words, to continue the example from above, instruction(s) with respect to the first mobile device may have been executed (e.g., the first user desired to listen to a song, or the instruction was selected for execution as a possible instruction, etc.). At least a portion of information resulting from such execution can be copied, or referenced, etc. for a similar instruction with respect to the second mobile device. Thus, by sharing information amongst states of the plurality of instances, the processing time needed to execute an instruction pertaining to a second instance can be reduced when at least a portion of the instruction has already been executed with respect to a first instance.

In an example, information resulting from executing instructions can be shared amongst different computing environments. In another example, such information can be pre-made and used to initialize a computing environment. Adding such information to a computing environment can reduce the processing time when instructions corresponding to the information are desirably executed. The computing environment may be configured to retain a predetermined amount of such information, and further may be configured to purge portions of such information after portions have been retained for predetermined time, after portions have not been referenced or used after a predetermined time, etc.

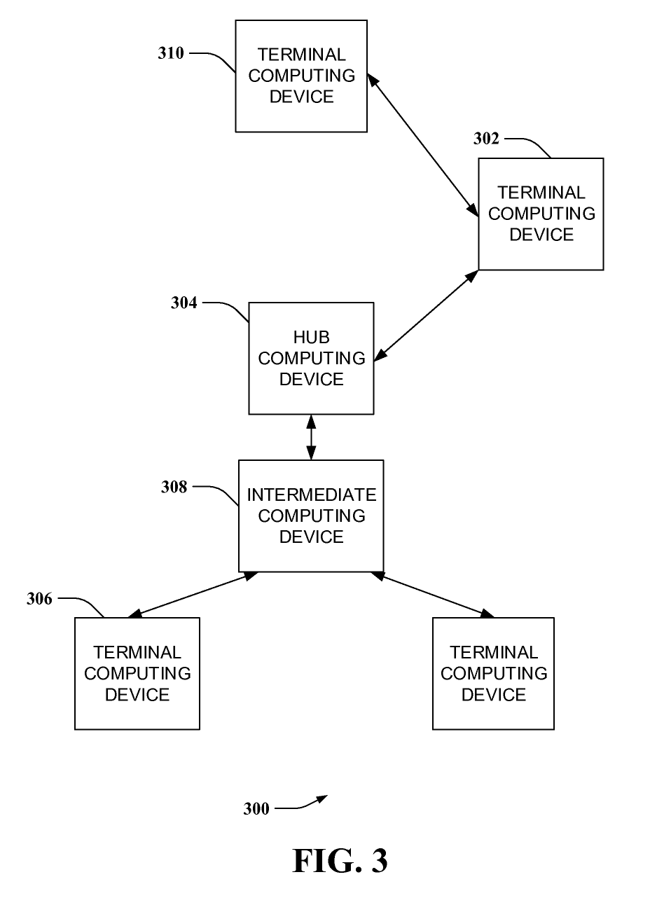

As described above, components of the computing environment as well as the processor module 104 may be distributed amongst a plurality of devices. The following examples of configurations of devices in a computing environment are included for illustration, and are not intended to be limiting, as other configurations are also contemplated. FIG. 3 is a functional block diagram of an exemplary computing environment 300. While the computing environment 300 illustrated in FIG. 3 comprises a plurality of computing devices, it should be understood that other exemplary computing environments comprise different numbers of computing devices and in different configurations.

The computing environment 300 may comprise one or more terminal computing device such as terminal computing device 302. In other embodiments (not pictured) no terminal computing devices are currently connected to the computing environment. Terminal computing devices are devices by which a user or another device interact with the computing environment 300 such as, for example, desktop computers, mobile devices, terminals, laptops, etc. The at least one terminal computing device(s) each comprise at least a respective portion of the interaction component. For example, the terminal computing device 302 may comprise a client instance of an application as discussed above. The interaction component is thus configured to receive input from buttons, sensors, etc., of the terminal computing device 302 and output information corresponding to a current state on output components of the terminal computing device 302 such as a screen, speakers, antenna, etc.

It is also contemplated that the terminal computing device 302 may be equipped with hardware having varying storage and computing capacity. Such storage capacity determines how many possible states a terminal can store at a given time. Therefore, a larger storage capacity increases the probability that the eventual user instruction will have been pre-executed and stored on the terminal. A sufficiently large storage capacity may allow for the terminal computing device 302 to store states associated with every possible instruction receivable in a current state; i.e., all possible horizontal instructions are pre-executed. It may also be desirable to execute a number of possible future instructions based on vertical predictions, so that the terminal stores potential states that might be needed more than one instruction in the future, further decreasing a risk of latency.

In some embodiments, the computing environment 300 comprises a hub computing device 304 that is in communication with the at least one terminal computing device. Hub computing devices can be centralized computing systems such as a data center, server farm, etc. The hub computing device comprises at least a portion of each of the processor module, state management component, instruction execution component, prediction component, and communication component. Thus, the state management component can determine a current state of the computing environment 300, e.g., with respect to a current state of the terminal computing device 302, and can identify possible instruction(s) receivable by the terminal computing device 302 that correspond to respective possible states as described above. The prediction component can prune the prediction space, and the instruction execution component can cause the processor module to execute at least one possible instruction. Thus, at least a portion of the prediction space is computed on a device other than the terminal computing device 302, whereby such information can be transmitted to the terminal computing device 302 via the communication component.

In some instances, a terminal computing device 306 is in communication with the hub computing device 304 via an intermediate computing device 308. Intermediate computing devices may be, for example, content distribution systems, relay servers, etc., and can also comprise at least a portion of at least one of the processor module, state management component, prediction component, and communication component. In other words, actions that may be performed by such components may be performed at the hub computing device and/or distributed amongst other computing devices such as the intermediate computing device 308. Such activities may be distributed based on a variety of factors including, but not limited to, geographical location of the intermediate device 308 relative to the terminal computing device 306, geographical location of the hub computing device 304 in relation to the terminal computing device 306 and the intermediate computing device 308, a current processing capacity of the hub computing device 304, terminal computing device 306, and/or intermediate computing device 308, processing costs associated with executing portions of the prediction space, and other factors.

The computing environment 300 may, for example, identify a number of possible instructions. A first tier of predicted instructions, determined to be most likely, may be executed and transmitted to the terminal computing device 306 for storage; a second tier of identified possible instructions, determined to be less likely, may be executed and transmitted to an intermediate computing device 308 for storage. Should one of the tier two instructions be issued to the computing environment, the executed instruction can be transmitted to the terminal computing device 306 from the intermediate computing device 308 with lower latency than if it had been transmitted from more distant resources. An intermediate computing device 308 may also be used to execute all or a portion of the possible instructions.

In some embodiments, the terminal computing device 306 may have limited or no processing capacity, whereby most or all processing required by an instance of an application corresponding to the terminal computing device 306 is executed by the hub computing device 304 and/or the intermediate computing device 308. In some embodiments, the terminal computing device comprises sufficient processing power to execute at least a portion of the prediction space. Thus, the terminal computing device 306 may also comprise at least a portion of at least one of the processor module, state management component, prediction component, or communication component.

For example, a terminal computing device may include a graphics processor and may include an application processor. This feature of the present invention allows the terminal computing device and other computing devices in the computing environment 300 to share responsibility of advancing the computing environment, and performing calculations. In an embodiment, the terminal computing device 302 executes all instructions that require less than a threshold amount of computation. Instructions that are more computationally intense are executed remotely, such as by the hub computing device 304, the result of which is transmitted to the terminal computing device. Such a system may also utilize the prediction framework described above. The computing environment 300 may predict potential instructions, determine where such instructions will be executed, and where results of such execution will be stored.

Terminal computing devices may be in communication with one another for purposes of user communication, data transfer, or other purposes. In some embodiments, processing capacity of one terminal computing device 302 can be used to process instructions corresponding to another terminal computing device 310. In other words, in some embodiments, a terminal device 302 can act as an intermediary device for another terminal device 310. In some embodiments, the computing environment fails to comprise a hub computing device, and processing for the at least one terminal computing devices is distributed amongst the at least one terminal computing devices, or other distributed computing devices.

An amount of a prediction space selected for execution by the instruction execution component may depend on a current condition and/or processing capacity of the computing environment 300. For example, more of the prediction space may be executed as more intermediary computing devices and/or terminal computing devices acting as intermediary computing devices are connected to the computing environment. Processing may also be redistributed upon computing devices connecting to or disconnecting from the computing environment 300. For example, processing may be distributed amongst the at least one terminal computing devices when the hub computing device 304 disconnects due to, for example, system error or malfunction, maintenance, or etc.

In some embodiments (not pictured) the state management component and/or predictor component is embodied within one or more computing devices distinct from the processor module and/or other components described above. Computational costs of isolated components may be high, such as when the prediction space and/or selection space is large and/or complex. Dividing such components amongst several computing devices may promote an efficient distribution of processing costs amongst the components. In some instances, different components are hosted on different virtual machines running on one or more distributed devices, wherein memory and/or processing power can be distributed amongst the components as needed.

The technologies described above can be utilized in a variety of fields for a variety of purposes. The following examples of such use are included for the purposes of illustration only, and should not be read as limitations of the scope of the invention. Such systems as described below exhibit an amount of deadweight time, as described above. Such deadweight time may be arbitrated through use of a state management component, prediction component, etc., in order to reduce latency amongst the thin user clients.

Hosting thin user client terminals has many benefits in the business setting. Businesses generally need a large number of computers in order to support the needs of its employees. Thin user clients are less expensive than independent computing devices, and are generally easier to manage in terms of software and support. However, conventional thin user client solutions have limited utility due to issues involving latency. Computationally intensive tasks such as modeling, video editing, design, drafting, programming, etc., are generally not suited to thin user clients hosted by a central server, as inherent delays in processing and communication make such tasks frustrating or unusable. By reducing latency in the manner described above, thin user clients can achieve lower latency, and thus higher usability for computationally intensive tasks.

Distributed applications, such as social networking applications, media sharing applications, communications applications, etc., generally involve communications amongst a large number of devices. Reducing latency in the manner described above can improve a user experience.

Software such as video games generally constrained by limitations of devices used to run them. New games generally require new hardware to run properly, which can be costly as it generally includes expensive hardware. By using the technologies described above, cheaper thin device clients can be developed that support user interactions, while computationally intensive tasks such as simulations, calculations, etc., are performed remotely, where economies of scale and performance can be optimized. Reduction in latency can make such systems responsive on an order of 100 ms or less, such that a user perceives an uninterrupted experience.

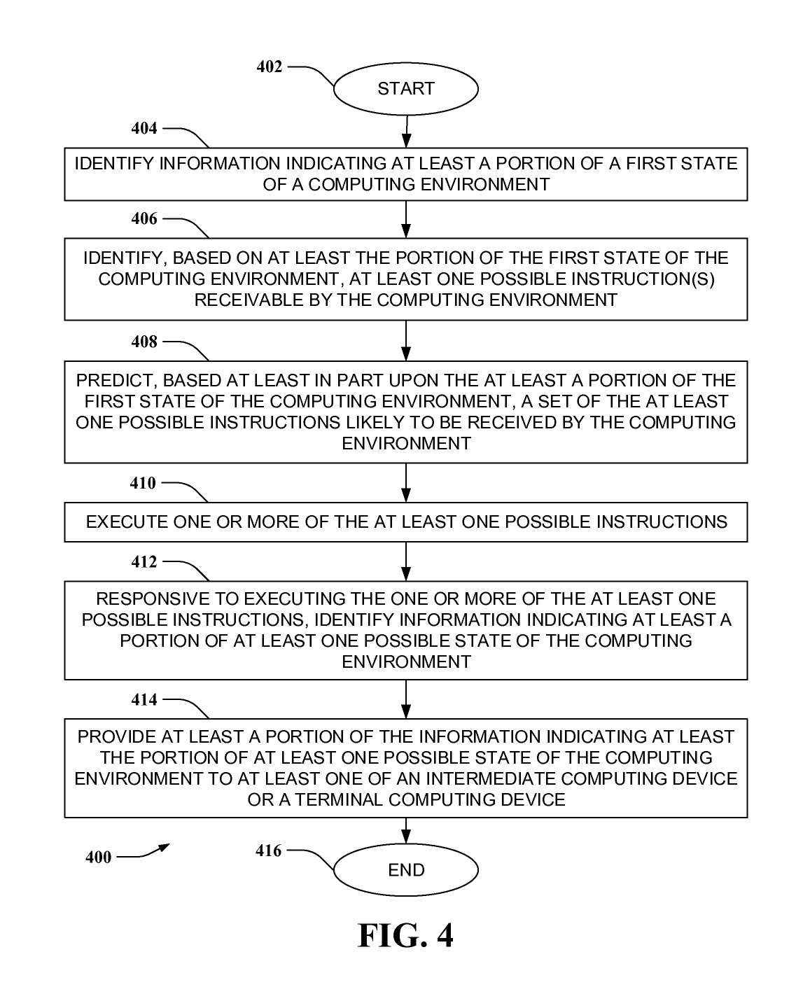

With reference now to FIG. 4, an exemplary methodology is illustrated and described. While the methodology is described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement a methodology described herein.

FIG. 4 illustrates an exemplary methodology 400 that facilitates anticipatory execution and provision of possible instructions receivable by a computing environment. The methodology starts at 402, and at 404, information indicating at least a portion of a first state of a computing environment is identified. At 406, at least one possible instruction receivable by the computing environment is identified based at least on at least the portion of the first state of the computing environment. At 408, a set of the at least one possible instructions likely to be received by the computing environment is predicted based at least in part upon the at least a portion of the first state of the computing environment. At 410, one or more of the at least one possible instructions is executed. At 412, information indicating at least a portion of at least one possible state of the computing environment is identified responsive to executing the one or more of the at least one possible instructions. At 414, at least a portion of the information indicating at least the portion of the at least one possible state of the computing environment is provided to at least one of an intermediate computing device or a terminal computing device. The methodology ends at 416.

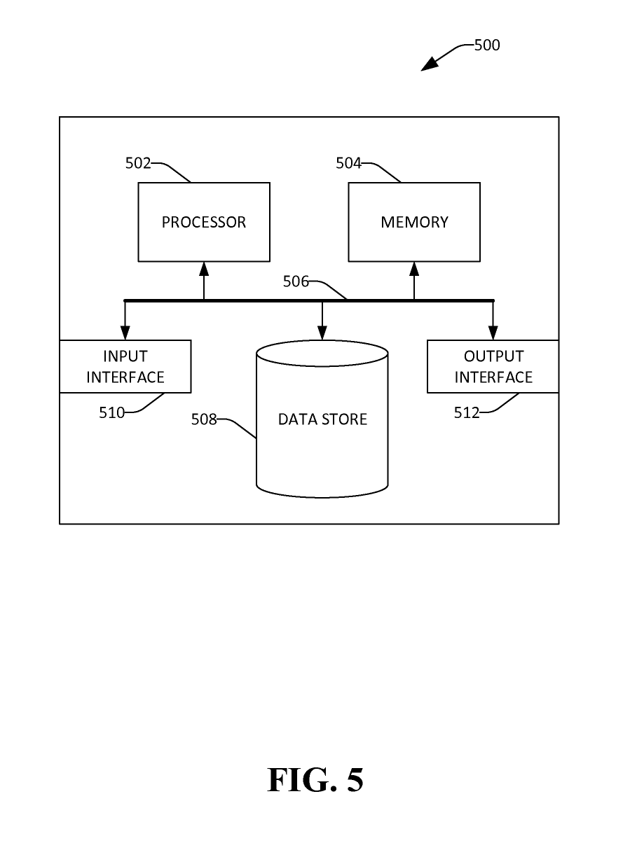

Referring now to FIG. 5, a high-level illustration of an exemplary computing device 500 that can be used in accordance with the systems and methodologies disclosed herein is illustrated. For instance, the computing device 500 may be used in a computing environment that facilitates anticipatory execution and provision of possible instructions receivable by a computing environment. The computing device 500 includes at least one processor 502 that executes instructions that are stored in a memory 504. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store state information, prediction space information, information resulting from execution of possible instructions, etc.

The computing device 500 additionally includes a data store 508 that is accessible by the processor 502 by way of the system bus 506. The data store 508 may include executable instructions, etc. The computing device 500 also includes an input interface 510 that allows external devices to communicate with the computing device 500. For instance, the input interface 510 may be used to receive instructions from an external computer device, from a user, etc. The computing device 500 also includes an output interface 512 that interfaces the computing device 500 with one or more external devices. For example, the computing device 500 may display text, images, etc. by way of the output interface 512.

It is contemplated that the external devices that communicate with the computing device 500 via the input interface 510 and the output interface 512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 500 in a manner free from constraints imposed by input device such as keyboards, mice, remote controls, and the like. For example, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for instance, several devices may be in communication by way of a network connection and may collectively perform tasks described as being performed by the computing device 500.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Furthermore, to the extent that the term “includes” is used in either the details description or the claims, such term is intended to be inclusive in a manner similar to the term “comprising” as “comprising” is interpreted when employed as a transitional word in a claim.

1. A method, executed by a processor module of a computing environment, the method comprising:
identifying information indicating at least a portion of a first state of the computing environment;
identifying, based on at least the portion of the first state of the computing environment, at least one possible instructions receivable by the computing environment in the first state; and
executing one or more of the at least one possible instructions.

2. The method of claim 1, further comprising:
identifying information indicating at least a portion of at least one possible state of the computing environment; and
identifying, based on at least the information indicating at least a portion of the at least one possible state of the computing environment, at least one possible instruction receivable by the computing environment in the at least one possible state.

3. The method of claim 2, further comprising providing the information indicating at least a portion of the at least one possible state of the computing environment to a terminal computing device.

4. The method of claim 3, wherein the terminal computing device performs at least a portion of the executing of the one or more of the at least one possible instructions.

5. The method of claim 2, wherein the terminal computing device is an intermediate computing device of a second terminal computing device.

6. The method of claim 2, further comprising providing the information indicating at least a portion of the at least one possible state of the computing environment to an intermediate computing device.

7. The method of claim 6, wherein the intermediate computing device performs at least a portion of the executing of the one or more of the at least one possible instructions.

8. The method of claim 6, further comprising providing at least a portion of the information provided to the intermediate computing device to a terminal computing device.

9. The method of claim 8, wherein providing the information to the intermediate computing device is based at least in part upon a geographical location of the intermediate computing device relative to the terminal computing device.

10. The method of claim 1, further comprising predicting, based at least in part upon the at least a portion of the first state of the computing environment, a set of the at least one possible instructions likely to be received by the computing environment.

11. The method of claim 10, wherein the one or more of the at least one possible instructions executed is the set of the at least one possible instructions likely to be received by the computing environment.

12. The method of claim 1, wherein one of the at least one possible instructions is an instruction that can be received by the computing environment subsequent to receiving another of the at least one possible instructions.

13. The method of claim 1, wherein a possible instruction comprises at least one of machine code, executable computer code, a GUI interaction, a user interaction, or a received signal.

14. A computing system comprising:
a processor module; and
a memory, the memory comprising a plurality of components executable by the processor module, the plurality of components comprising:
a state management component configured to:
identify information indicating at least a portion of a first state of a computing environment; and
based on the at least a portion of the first state of the computing environment, identify at least one possible instruction receivable by the computing environment in the first state; and
an instruction execution component configured to execute one or more of the at least one possible instructions.

15. The system of claim 14, wherein the state management component is further configured to;
identify information indicating at least a portion of at least one possible state of the computing environment; and
identify, based on at least the information indicating at least a portion of the at least one possible state of the computing environment, at least one possible instruction receivable by the computing environment in the at least one possible state.

16. The system of claim 15, further comprising a communication component configured to provide the information indicating at least a portion of the at least one possible state of the computing environment to a terminal computing device.

17. The system of claim 15, further comprising a communication component configured to provide the information indicating at least a portion of the at least one possible state of the computing environment to an intermediate computing device.

18. The system of claim 14, further comprising a predictor component configured to predict, based at least in part upon the at least a portion of the first state of the computing environment, a set of the at least one possible instructions likely to be received by the computing environment.

19. The method of claim 18, wherein the set of the at least one possible instructions likely to be received by the computing environment is the one or more of the at least one possible instructions executable by the instruction execution component.

20. A computer-readable data storage device comprising instructions that, when executed by a processor of a computing device, cause the processor to perform acts comprising:
identify information indicating at least a portion of a first state of the computing environment;
predict, based on at least the portion of the first state of the computing environment, at least one possible instructions likely to be received by the computing environment in the first state, wherein a possible instruction comprises at least one of machine code, executable computer code, a GUI interaction, a user interaction, or a received signal receivable by the computing environment;
execute one or more of the at least one possible instructions;
identify a portion of results from execution of the one or more of the at least one possible instructions as information indicating at least a portion of at least one possible state of the computing environment;
identify, based on at least the information indicating at least a portion of the at least one possible state of the computing environment, at least one possible instruction receivable by the computing environment in the at least one possible state;
execute one or more of the at least one possible instructions receivable by the computing environment in the at least one possible state;
identify a portion of results from execution of the one or more of the at least one possible instructions receivable by the computing environment in the at least one possible state as information indicating at least a portion of at least one future possible state of the computing environment; and
provide the information indicating at least a portion of the at least one possible state of the computing environment and the information indicating at least a portion of at least one future possible state of the computing environment to a terminal computing device.
